(19) United States
(12) Patent Application Publication
(10) Pub. No.: US 2007/0005228 A1
(43) Pub. Date: Jan. 4, 2007

(54) GPS-based traffic monitoring system

(76) Inventor: Sehat Sutardja, Los Altos Hills, CA (US)

Correspondence Address: HARNESS, DICKEY & PIERCE P.L.C., 5445 CORPORATE DRIVE, SUITE 400, TROY, MI, 48098, US

(21) Appl. No.: 11/338,978

(22) Filed: Jan. 25, 2006

Related U.S. Application Data
(63) Continuation-in-part of application No. 11/171,563, filed on Jun. 30, 2005.

(51) Int. Cl. G06F 19/00

(52) U.S. Cl. 701/117; 340/933

(57) ABSTRACT

A traffic information system for a vehicle comprises a global positioning system (GPS) associated with the vehicle that selectively generates location and vector data. The traffic information system includes a transmitter. A control module receives the location and vector data and wirelessly transmits the location and vector data using the transmitter. A remote traffic monitoring system receives the location and vector data and determines a first lane that the vehicle is located in based on at least the location and vector data.

This application is a continuation-in-part of U.S. patent application Ser. No. 11/171,563 filed on Jun. 30, 2005. The disclosure of the above application is incorporated herein by reference.

### FIELD OF THE INVENTION

The present invention relates to traffic monitoring systems, and more particularly to global positioning system (GPS)-based traffic monitoring systems for vehicles.

### BACKGROUND OF THE INVENTION

Global positioning systems (GPS) for vehicles typically include a receiver that triangulates vehicle position using beacons generated by GPS satellites. These systems also typically include a map database that is used to provide the location of the vehicle on a map, driving directions, the location of restaurants and other businesses, and/or other information. As cities become more populated, it has become more difficult to travel without incurring delays due to traffic congestion, accidents, construction and/or other problems. Finding parking in congested cities can also be difficult.

### SUMMARY OF THE INVENTION

A traffic information system for a vehicle comprises a global positioning system (GPS) associated with the vehicle that selectively generates location and vector data and a transmitter. A control module receives the location and vector data and wirelessly transmits the location and vector data using the transmitter. A remote traffic monitoring system that receives the location and vector data determines a first lane that the vehicle is located in based on at least the location and vector data.

In other features of the invention, a receiver communicates with the control module and wirelessly receives traffic reports from the remote traffic monitoring system. The traffic reports include traffic speed information for traffic traveling on at least the first lane. A system comprising the traffic information system further comprises a service assistance system that communicates with the control module and that wirelessly communicates with a remote service assistance system. The remote traffic monitoring system receives the vector and location data, compares a speed of the vehicle in the first lane to a first threshold and to at least one of an average traffic speed on a road including the first lane and an average traffic speed of a second lane, and selectively triggers contact with the vehicle using the service assistance system and the remote service assistance system. The road includes the second lane.

In other features of the invention, the control module transmits the vector and location data on a periodic basis. The control module monitors lane changes of the vehicle and transmits the vector and location data when the vehicle changes lanes greater than a lane change frequency threshold. The control module monitors changes in speed of the vehicle and transmits the vector and location data when the vehicle speed change is greater than a speed change threshold. The control module is integrated with the GPS. The remote traffic monitoring system determines a lane of an accident based on at least the location and vector data. The remote traffic monitoring system generates a lane change suggestion according to the location and vector data.

In other features of the invention, the remote traffic monitoring system determines a direction of travel of the vehicle based on the location and vector data. The traffic reports include a confidence level associated with the location and vector data. The confidence level is high when the location and vector data indicates that the vehicle is traveling at a first speed and the confidence level is low when the location and vector data indicates that the vehicle is traveling at a second speed.

A traffic information system for a vehicle comprises global positioning means associated with the vehicle for selectively generating location and vector data, transmitting means fog transmitting data, and control means for receiving the location and vector data and for wirelessly transmitting the location and vector data using the transmitting means, wherein the control means communicates with remote traffic monitoring means for receiving the location and vector data and for determining a first lane that the vehicle is located in based on at least the location and vector data.

In other features of the invention, the traffic information system further comprises receiving means for communicating with the control means and for wirelessly receiving traffic reports from the remote traffic monitoring means. The traffic reports include traffic speed information for traffic traveling on at least the first lane. A system comprising the traffic information system further comprises service assistance means for communicating with the control means and for wirelessly communicating with remote service assistance means for receiving the vector and location data. The system further comprises the remote traffic monitoring means for comparing a speed of the vehicle in the first lane to a first threshold and to at least one of an average traffic speed on a road including the first lane and an average traffic speed of a second lane, and for selectively triggering contact with the vehicle using the service assistance means and the remote service assistance means. The road includes the second lane.

In other features of the invention, the control means transmits the vector and location data on a periodic basis. The control means monitors lane changes of the vehicle and transmits the vector and location data when the vehicle changes lanes greater than a lane change frequency threshold. The control means monitors changes in speed of the vehicle and transmits the vector and location data when the vehicle speed change is greater than a speed change threshold. The control means is integrated with the GPS. The traffic information system further comprises the remote traffic monitoring means for determining a lane of an accident based on at least the location and vector data. The remote traffic monitoring means generates a lane change suggestion according to the location and vector data.

In other features of the invention, the remote traffic monitoring means determines a direction of travel of the vehicle based on the location and vector data. The traffic reports include a confidence level associated with the location and vector data. The confidence level is high when the location and vector data indicates that the vehicle is traveling at a first speed and the confidence level is low when the location and vector data indicates that the vehicle is traveling at a second speed.

A method of monitoring traffic information for a vehicle comprises selectively generating location and vector data of the vehicle, receiving the location and vector data at a control module, wirelessly transmitting the location and vector data, receiving the location and vector data at a remote traffic monitoring system, and determining a first lane that the vehicle is located in based on at least the location and vector data at the remote traffic monitoring system.

In other features of the invention, the method further comprises wirelessly receiving traffic reports from the remote traffic monitoring system. The traffic reports include traffic speed information for traffic traveling on at least the first lane. The method further comprises communicating with a service assistance system and wirelessly communicating with a remote service assistance system. The method further comprises comparing a speed of the vehicle in the first lane to a first threshold and to at least one of an average traffic speed on a road including the first lane and an average traffic speed of a second lane, and selectively triggering contact with the vehicle using the service assistance system and the remote service assistance system. The road includes the second lane.

In other features of the invention, the method further comprises wirelessly transmitting the location and vector data on a periodic basis. The method further comprises monitoring lane changes of the vehicle and transmitting the vector and location data when the vehicle changes lanes greater than a lane change frequency threshold. The method further comprises monitoring changes in speed of the vehicle and transmitting the vector and location data when the vehicle speed change is greater than a speed change threshold. The method further comprises integrating the control module with a global positioning system (GPS). The method further comprises determining a lane of an accident based on at least the location and vector data. The method further comprises generating a lane change suggestion according to the location and vector data.

In other features of the invention, the method further comprises determining a direction of travel of the vehicle based on the location and vector data. The method further comprises generating a confidence level associated with the location and vector data. The confidence level is high when the location and vector data indicates that the vehicle is traveling at a first speed and the confidence level is low when the location and vector data indicates that the vehicle is traveling at a second speed.

A computer program stored on a computer-readable medium and executed by a processor comprises selectively generating location and vector data of a vehicle, receiving the location and vector data at a control module, wirelessly transmitting the location and vector data, receiving the location and vector data at a remote traffic monitoring system, and determining a first lane that the vehicle is located in based on at least the location and vector data at the remote traffic monitoring system.

In other features of the invention, the computer program further comprises wirelessly receiving traffic reports from the remote traffic monitoring system. The traffic reports include traffic speed information for traffic traveling on at least the first lane. The computer program further comprises communicating with a service assistance system and wirelessly communicating with a remote service assistance system. The computer program further comprises comparing a speed of the vehicle in the first lane to a first threshold and to at least one of an average traffic speed on a road including the first lane and an average traffic speed of a second lane, and selectively triggering contact with the vehicle using the service assistance system and the remote service assistance system. The road includes the second lane.

In other features of the invention, the computer program further comprises wirelessly transmitting the location and vector data on a periodic basis. The computer program further comprises monitoring lane changes of the vehicle and transmitting the vector and location data when the vehicle changes lanes greater than a lane change frequency threshold. The computer program further comprises monitoring changes in speed of the vehicle and transmitting the vector and location data when the vehicle speed change is greater than a speed change threshold. The computer program further comprises integrating the control module with a global positioning system (GPS). The computer program further comprises determining a lane of an accident based on at least the location and vector data. The computer program further comprises generating a lane change suggestion according to the location and vector data.

In other features of the invention, the computer program further comprises determining a direction of travel of the vehicle based on the location and vector data. The computer program further comprises generating a confidence level associated with the location and vector data. The confidence level is high when the location and vector data indicates that the vehicle is traveling at a first speed and the confidence level is low when the location and vector data indicates that the vehicle is traveling at a second speed.

In still other features, the systems and methods described above are implemented by a computer program executed by one or more processors. The computer program can reside on a computer readable medium such as but not limited to memory, non-volatile data storage and/or other suitable tangible storage mediums.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 illustrates an exemplary traffic monitoring system that monitors vehicle traffic according to the present invention;

FIGS. 2A and 2B are functional block diagrams of exemplary vehicles including a GPS, a transceiver, a control module and a display;

FIG. 3A is a functional block diagram of the exemplary vehicle of FIG. 2A with a remote service assistance (RSA) system;

FIG. 3B is a functional block diagram of the exemplary vehicle of FIG. 2A with an alternate RSA system;

FIG. 4 is a functional block diagram of portions of an exemplary traffic monitoring system;

FIG. 5 is a flow chart illustrating exemplary steps performed by a vehicle for transmitting data;

FIG. 6 is a flow chart illustrating first alternate exemplary steps performed by a vehicle for transmitting data;

FIG. 7A is a flow chart illustrating exemplary steps performed by the traffic monitoring system for transmitting parking-related data;

FIG. 7B is a flow chart illustrating alternate exemplary steps performed by the traffic monitoring system for transmitting parking-related data;

FIG. 8 is a flow chart illustrating steps performed by the traffic monitoring system for receiving and processing traffic and parking data;

FIG. 9 illustrates steps performed by the traffic monitoring system for monitoring parking;

FIG. 10 illustrates steps performed by the traffic monitoring system and the RSA system for identifying vehicles having operational problems;

FIG. 11 illustrates an exemplary map display with average vehicle speeds on roads, accidents, construction and/or other items;

FIG. 12 illustrates an exemplary display of available parking in the vicinity of the vehicle;

FIG. 13A illustrates steps performed by the traffic monitoring system to identify possible vehicle accidents;

FIG. 13B illustrates steps performed by the traffic monitor system for updating traffic information based on lanes that vehicles are traveling in;

FIG. 14 illustrates steps performed by an exemplary traffic and/or parking information subscriber system; and

FIG. 15 illustrates steps performed by another exemplary traffic and/or parking information subscriber system.

### DETAILED DESCRIPTION OF THE PREFERRED EMBODIMENTS

The following description of the preferred embodiment(s) is merely exemplary in nature and is in no way intended to limit the invention, its application, or uses. For purposes of clarity, the same reference numbers will be used in the drawings to identify similar elements.

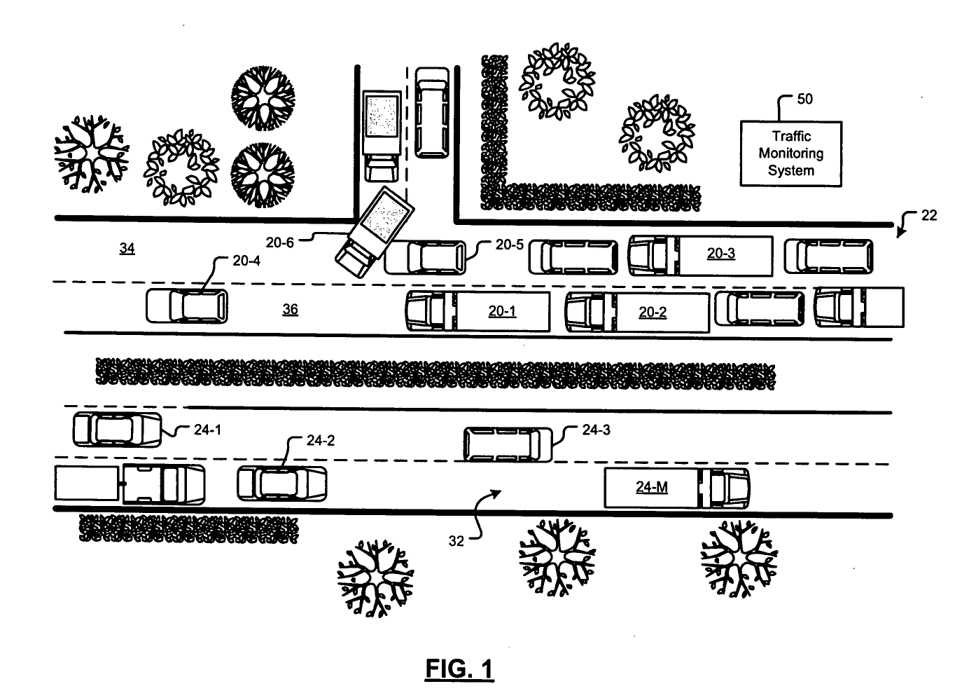

Referring now to FIG. 1, an exemplary traffic monitoring system that monitors vehicle traffic according to the present invention is shown. Vehicles 20-1, 20-2, . . . , and 20-N (generally identified as vehicles 20) travel on a road in a first direction generally identified at 22. Vehicles 24-1, 24-2, . . . , and 24-M (generally identified as vehicles 24) travel on the road in a second direction generally identified at 32. For example, vehicles 20-5 and 20-6 are involved in an accident, which slows the flow of traffic in the first direction 22. The accident does not slow traffic moving in the second direction 32. The traffic monitoring system alerts motorists of the slow traffic on the road traveling in the first direction, as well as information relating to traffic on other freeways, streets and other major thoroughfares.

The traffic monitoring system may further alert motorists of slow traffic in a specific lane of a road. For example, the accident involving the vehicles 20-5 and 20-6 is located in a first lane 34. The accident does not prevent travel in a second lane 36. The traffic monitoring system determines that the accident is located in the first lane 34 and may direct motorists to travel in the second lane 36 instead of the first lane 34 (i.e. direct motorists to change lanes to avoid the accident).

According to the present invention, some of the vehicles 20 and 24 include global positioning systems (GPS) that include receivers that triangulate vehicle position based on signals generated by GPS satellites. In addition, the GPS may include an integrated transmitter and/or transceiver that transmits vector and location data wirelessly to a traffic monitoring system 50, which is located remotely from the vehicles 20 and 24. Alternately, a separate transmitter and/or transceiver may be used in conjunction with a receiver-only GPS. The vector data may include speed and direction data. The location data may include longitude and latitude information or location information using another coordinate system. For example, the location data may indicate whether the vehicle is traveling in the first lane 34 or the second lane 36.

The traffic monitoring system 50 receives the vector and location data, performs calculations on the data and transmits traffic and/or parking information back to the vehicles 20 and 24 with GPS systems with integrated transmitters and/or transceivers and/or GPS systems with separate transmitters and/or transceivers as will be described further below. The GPS systems of the vehicles provide visual and/or audible traffic information to allow drivers to avoid traffic bottlenecks such as the accident and/or to find parking spots.

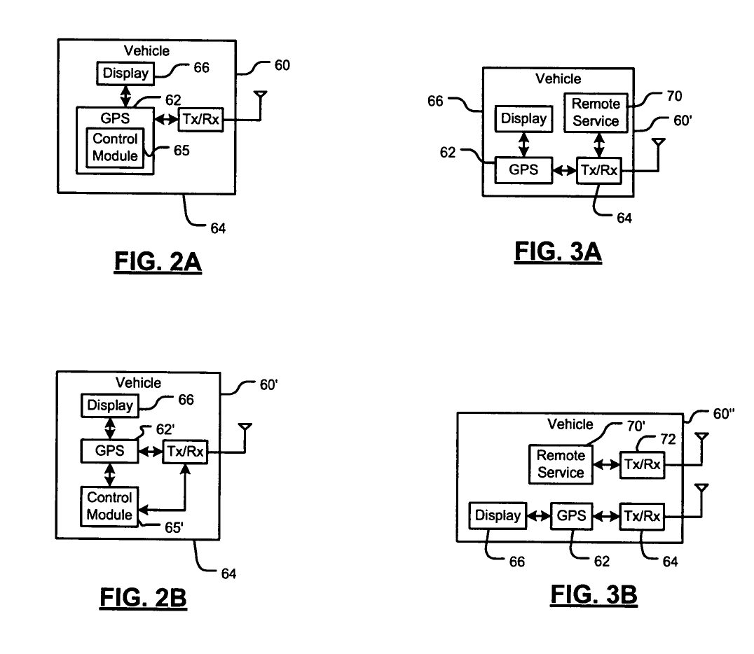

Referring now to FIGS. 2A, 2B, 3A and 3B, several exemplary vehicle configurations are shown. While specific examples are shown, other configurations may be used. In FIG. 2A, a vehicle 60 includes a GPS 62, a wireless transceiver 64 and a display 66. A control module 65 that is integrated with the GPS 62 performs control functions relating to traffic and/or parking information systems. The GPS 62 triangulates position or location data of the vehicle 60 and calculates vector data using GPS signals generated by GPS satellites. The vehicle 60 selectively transmits the location and vector data wirelessly via the transceiver 64 to the remote traffic monitoring system 50. The transceiver 64 periodically receives traffic data from the remote traffic monitoring system 50 as will be described further below. The GPS systems 62 outputs traffic and other GPS-related information using the display 66. In some implementations, the transceiver 64 may be integrated with the GPS 62. As can be appreciated, the control module 65 may be separate from the GPS 62 as shown at 62′ and 65′ in FIG. 2B.

In FIG. 3A, a vehicle 60′ that is similar to FIGS. 2A and 2B is shown and further comprises a vehicle-based remote service assistance system 70, which provides a connection to a main remote service assistance system and/or a service assistant. For example, one suitable remote service assistance system 70 is OnStar®, although other remote service assistance systems may be utilized. In FIG. 3A, the remote service assistance system 70 and the traffic monitoring system 50 share the common transceiver 64. In some implementations, the transceiver 64 may be integrated with the GPS 62 and/or the remote service system 70.

In FIG. 3B, a vehicle 60″ that is similar to FIGS. 2A and 2B is shown and further comprises an alternate remote service assistance system 70′. In FIG. 3B, the remote service assistance system 70′ utilizes a transceiver 72 that is separate from the transceiver 64 used by the GPS system 62. As can be appreciated, any suitable wireless systems may be employed including cellular systems, WiFi systems such as 802.11, 802.11a, 802.11b, 802.11g, 802.11n (which are hereby incorporated by reference), and/or other future 802.11 standards, WiMax systems such as 802.16 (which is hereby incorporated by reference) and/or any other suitable type of wireless system that allows communication over sufficient distances. In some implementations, one or both of the transceivers 64 and 72 are integrated with the GPS 62 and/or remote service system 70′. As in FIGS. 2A and 2B, the control module may be integrated with or separate from the GPS and/or other system components.

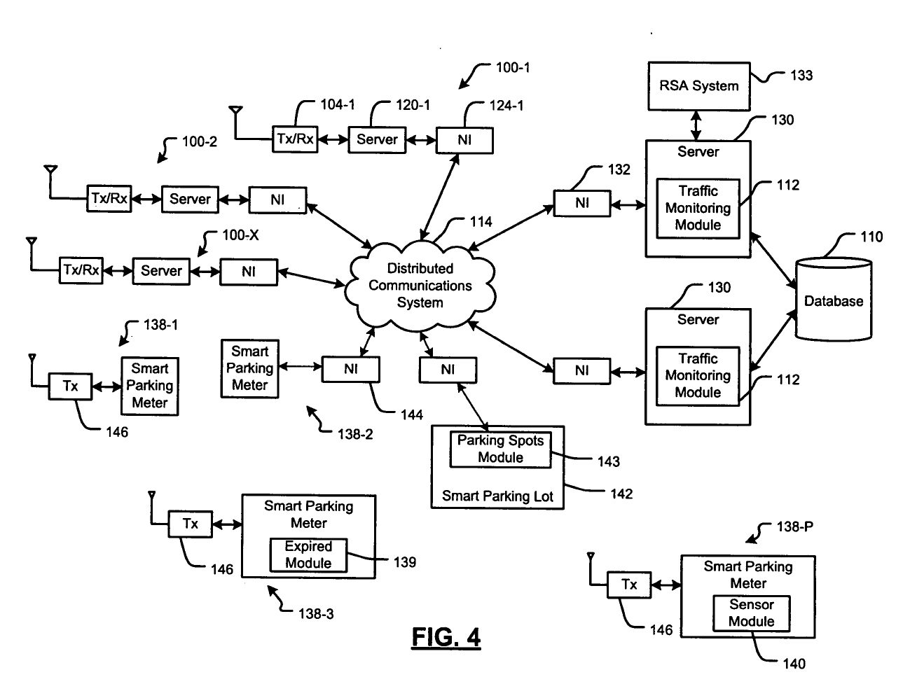

Referring now to FIG. 4, a functional block diagram of an exemplary traffic and/or parking monitoring system is shown. The traffic monitoring system includes a plurality of monitoring stations 100-1, 100-2, . . . , and 100-X (collectively monitoring stations 100) such as the station 50 shown in FIG. 1. The parking information can be provided in addition to or separate from the traffic information. The monitoring stations 100 include a transceiver 104. The monitoring stations 100 receive location and vector data from the vehicles and transmit traffic and/or parking information to the vehicles as will be described. To that end, the monitoring stations 100 are connected to one or more databases 110 that store traffic and/or parking information. Traffic monitoring modules or programs 112 analyze the data that is stored in the databases 110.

While the present invention will be described in conjunction with a distributed communications system 114, there are many other suitable ways of interconnecting the monitoring stations 100. The monitoring station 100-1 includes a server 120-1 and a network interface (NI) 124-1. The NI 124-1 provides a connection to the distributed communications system 114. In some implementations, the distributed communications system 114 includes the Internet, although any other type of network may be used. The databases 110 may also be connected to the distributed communications system 114 by servers 130 via NI 132. Other types of interconnection include dedicated phone lines, terrestrial links, satellite links and/or other suitable links may be used. The main RSA system 133 may communicate with one or more of the servers 130 and/or may have all independent links via the DCS 114. The system may use an inquiry response technique and/or a push technique for providing parking and/or traffic information.

In addition to the foregoing, a plurality of smart parking meters 138-1, 138-2, . . . , and 138-P (collectively smart parking meters 138) can be provided. The smart parking meters 138 provide an indication when the parking spot is filled or vacant. In some implementations, the smart parking meter 138 may make this decision based on a meter status signal generated by an expired module 139. The expired module generates the meter status signal having a spot filled state when the meter is running. The meter status signal has a spot vacant state when the meter expires. In other words, when the meter is expired,

Alternately, the smart parking meter 138 may include a sensor 140 that senses whether a vehicle is located in a corresponding parking spot. In some implementations, the sensor outputs a radio frequency signal in a direction towards the parking space and generates the meter status signal depending on reflected signals that are received. If the reflected signals are returned in a period less than a threshold and/or have an amplitude greater than a threshold, a vehicle is in the spot. If not, the spot is vacant. In some implementations, the reflected signals need to be less than the threshold for a predetermined period (to reduce noise). In still other embodiments, a group of meters may include a common sensor that senses the presence of one or more vehicles in one or more parking spots of the group. In addition, a parking lot 142 may include a parking spot module 143 that provides a collective signal that K parking spots are available in the entire parking lot 142. The smart parking meters 138 and smart parking lots 142 may be connected to the traffic monitoring system in any suitable manner including network interfaces (NI) 144, wireless transmitters 146 and/or in any other suitable manner. When transmitting the information, wireless or wired connections may be used.

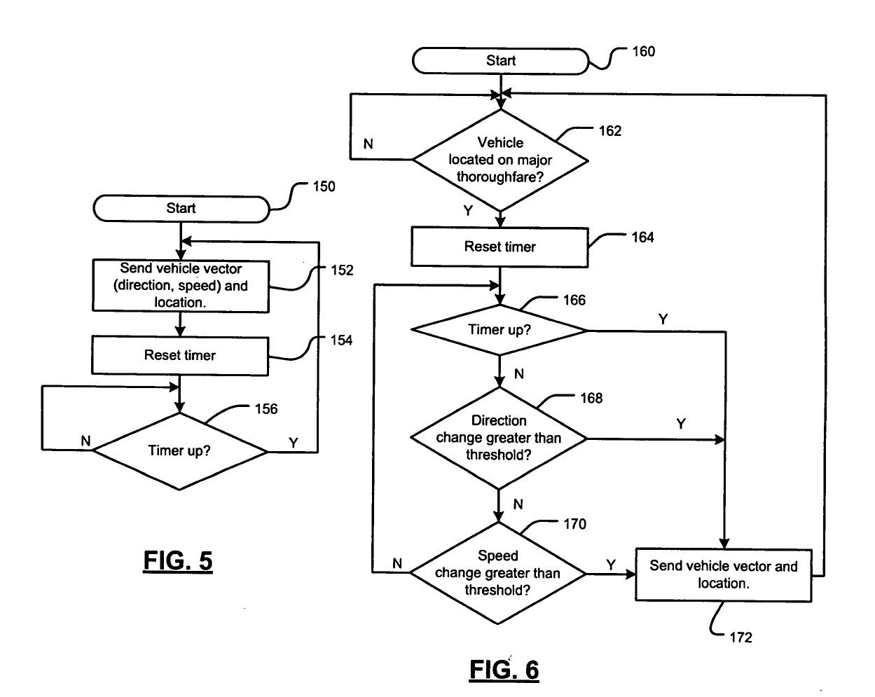

Referring now to FIG. 5, a flow chart illustrating exemplary steps performed by systems associated with the vehicle are shown. In this exemplary embodiment, the vehicle sends vehicle vector and location data on a periodic basis. The data transmission may be selectively enabled while the vehicle ignition is on, the vehicle ignition is on or off, the vehicle is moving and/or using other criteria. Control begins with step 150. In step 152, the vehicle sends vector and location data. In step 154, a timer is reset. In step 156, control determines whether a timer is up. If false, control returns to step 156. If step 156 is true, control returns to step 152. Control may be performed by the GPS system 62 or using any other control module in the vehicle. Alternately and/or in addition to the foregoing, the traffic monitoring system may periodically query the vehicle remotely for vector and/or location data. The vehicle responds to the query by sending the vector and/or location data.

Referring now to FIG. 6, a flow chart illustrating exemplary steps performed by systems associated with the vehicle are shown. Control begins with step 160. In step 162, control determines whether the vehicle is located on a major thoroughfare. For example, major thoroughfares may be defined to include freeways, highways and major streets. Major thoroughfares may exclude smaller streets, residential areas and low traffic streets to reduce the amount of data being sent. Since traffic is low on these types of roads, traffic information is not needed. If step 162 is false, control returns to step 162. If step 162 is true, control resets a timer in step 164. In step 166, control determines whether a timer is up. If not, control continues with step 168 and determines whether the vehicle has a direction change that is greater than a first threshold. If not, control continues with step 170 and determines whether the vehicle has incurred a speed change that is greater than a second threshold. Steps 166, 168 and 170 also tend to limit data being transmitted by the vehicle to the traffic monitoring system. One or more of these steps may be performed.

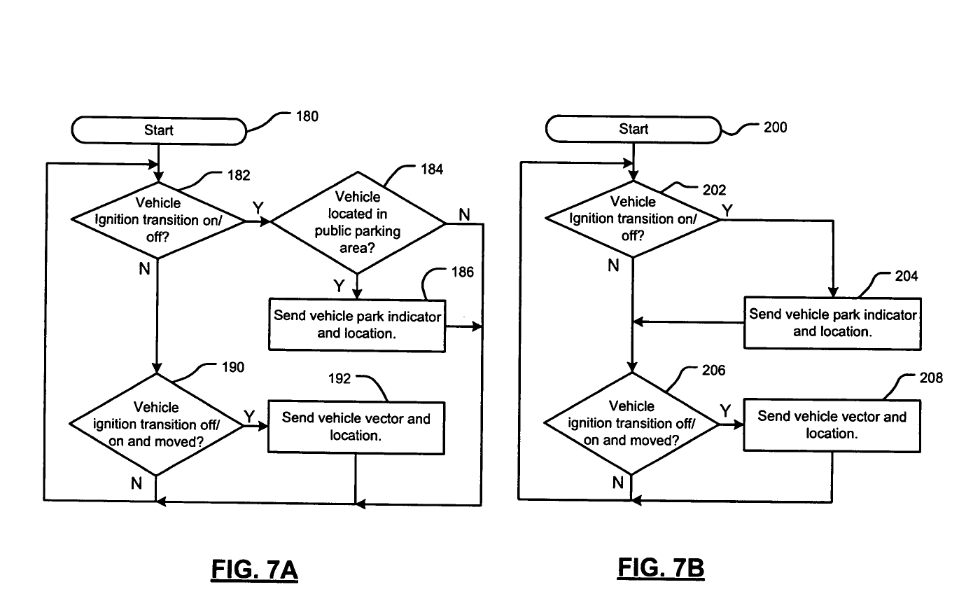

Referring now to FIG. 7A, a flow chart illustrating exemplary steps performed by the traffic monitoring system is shown. Control begins with step 180. In step 182, control determines whether the vehicle ignition transitions from on to off. If true, control determines whether the vehicle is located in a public parking area in step 184. This step may be performed by the vehicle alone and/or by the vehicle transmitting location information to the traffic monitoring system and receiving a response indicating whether the location is a parking spot in a public parking area. If step 184 is true, the vehicle sends a park indicator and location data in step 186. Control continues from step 186 to step 182. If step 184 is false, control returns to step 182. Therefore, the traffic monitoring system receives data related to parked vehicles.

If step 182 is false, control continues with step 190 and control determines whether the vehicle ignition transitions from off to on and the vehicle is moved. When the ignition turns on, it is likely that the vehicle may exit the parking space. If step 190 is true, control sends vehicle vector and location data to the traffic monitoring system in step 192 and control returns to step 182. If step 190 is false, control also continues with step 182. The traffic monitoring system uses the vehicle parking and vehicle leaving data to provide parking information to other vehicles.

Referring now to FIG. 7B, a flow chart illustrating alternate exemplary steps performed by the traffic monitoring system are shown. Control begins with step 200. In step 202, control determines whether the vehicle ignition transitions from on to off. If step 202 is true, control sends vehicle park indicator and location data in step 204 and as described above. If step 202 is false, control continues with step 206. In step 206, control determines whether the vehicle ignition transitions from off to on and the vehicle is moved. If true, control sends vehicle vector and location data. If step 206 is false, control returns to step 202.

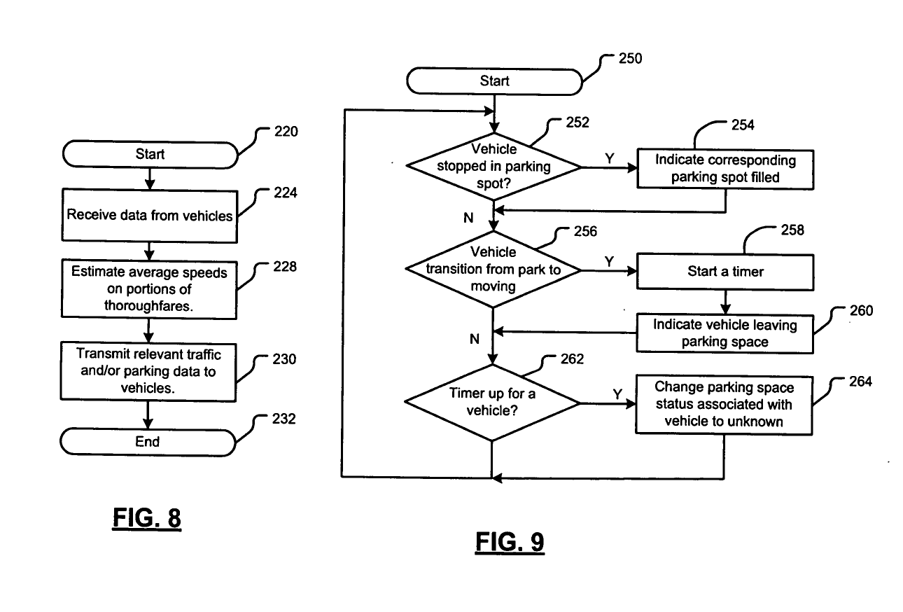

Referring now to FIG. 8, a flow chart illustrating data collection and analysis steps performed by the traffic monitoring system are shown. Control begins with step 220. In step 224, control receives data from the vehicles. In step 228, control estimates average speeds on selected portions of thoroughfares based on data from one or more vehicles. For example, the traffic monitoring system may estimate average speeds for predetermined distances or increments, and/or for specific lanes. The traffic monitoring system may also compare average speeds of different lanes. The increments may vary based on road type, conditions or calculated speeds. For example, as the difference between the average speeds and the posted speeds differ, the predetermined increment may be reduced in length.

Traffic information is transmitted to the vehicles based upon calculations made on the collected vehicle data. The traffic information may be pushed to the vehicles and/or an inquiry/response technique may be used in step 230. Control ends in step 232. In addition to traffic information, parking data may also be transmitted to the vehicles using a push technique and/or an inquiry/response technique.

The traffic monitoring system may perform the analysis steps based in part on a sample size of data collected from the vehicles. The traffic monitoring system generates a confidence level that is associated with the traffic information that is transmitted to the vehicles based on the sample size. For example, the traffic monitoring system may only receive data from a single vehicle or a number of vehicles below a threshold in a particular area. When data from the single vehicle indicates that the vehicle is traveling at a speed above a certain threshold, the traffic monitoring system can presume that other vehicles in the vicinity are traveling at similar speeds and generate a high confidence level.

Conversely, the data from the single vehicle may indicate that the vehicle is not moving or traveling below the threshold. The slow traveling speed may not necessarily indicate that the other vehicles in the vicinity are traveling at similar speeds. For example, the single vehicle may be stopped or slowed because of vehicle problems. When only a single vehicle or a low number of vehicles are stopped or traveling at a low speed, the traffic monitoring system generates a low confidence level to associate with the traffic information. The traffic monitoring system may flag the single vehicle to consider the prior data in subsequent confidence analyses.

Referring now to FIG. 9, steps performed by the traffic monitoring system for monitoring parking are illustrated. Control begins with step 250. In step 252, control determines whether a vehicle is stopped in a public parking spot. The decision may be based on location and vector data samples and/or based on a parking indicator and location data. The determination that the parking spot is a public spot is based on the location data. If true, control indicates that the corresponding public parking spot is filled in step 254.

Control continues from steps 252 and 254 with step 256. In step 256, control determines whether a vehicle transitions from parking to moving. If step 256 is true, control starts a timer in step 258. In step 260, control indicates that a vehicle is leaving a public parking space. The timer is used to limit the amount of time that the parking space is identified as “vehicle leaving”. Control continues from steps 256 and 260 with step 262. In step 262, control determines whether a timer for a vehicle is up. If step 262 is true, control changes a status of the parking space to unknown in step 264. Control continues from steps 262 and 264 with step 252.

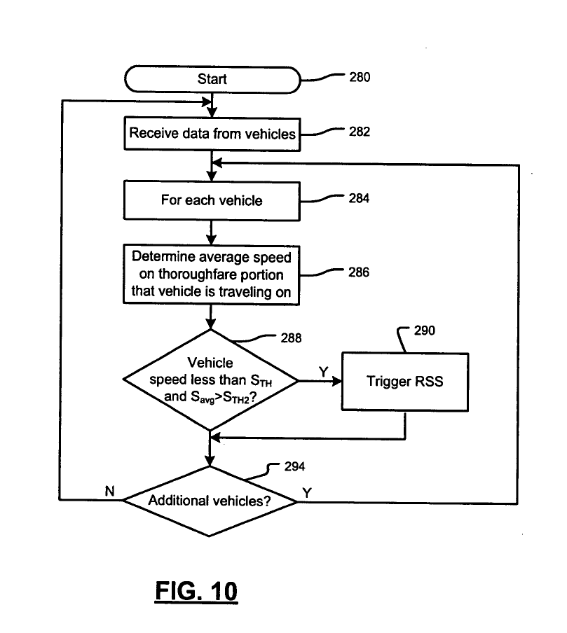

Referring now to FIG. 10, steps performed by the traffic monitoring system for identifying vehicles having operational problems are shown. Control begins with step 280. In step 282, control receives data from vehicles. In step 284 and 286, for each of the vehicles, control determines an average speed on a thoroughfare portion and lane that the vehicle is traveling on. In step 288, control determines whether the speed of each vehicle is less than a first speed threshold and the average speed on a thoroughfare is greater than a second speed threshold.

For example, if the average speed on a thoroughfare is 50 mph and the speed of the vehicle is less than 5 mph, the vehicle may be having operational problems and/or may have been involved in an accident and require assistance. Frequent speed changes and/or lane changes (e.g., lane changes greater than a lane change frequency threshold) may indicate other operational problems such as driver impairment. If step 288 is true, control triggers an inquiry via the remote service assistance system in step 290. For example, the traffic monitoring system notifies the main remote service assistance system to have a service assistant contact the driver of the vehicle. The service assistant can determine whether or not there is a problem such as an accident or other operational problem and contact emergency personnel, roadside assistance and/or other assistance as needed. For example, the service assistant may notify the emergency personnel of a location of the vehicle, including the thoroughfare portion and the lane that the vehicle is traveling in. Control continues from step 288 and 290 with step 294. In step 294, control determines whether there are additional vehicles to evaluate. If step 294 is true, control returns to step 284. If step 294 is false, control returns to step 282.

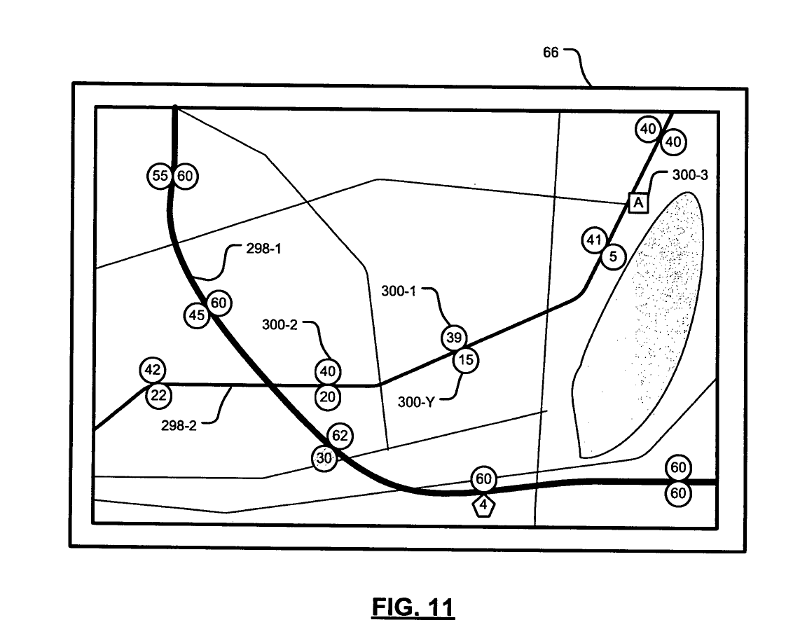

Referring now to FIG. 11, a display illustrating vehicle speeds on thoroughfares 298-1, 298-2, . . . and 298-Z is shown. The display 66 associated with the GPS system at 62 is shown. Visual elements generally identified by 300-1, 300-2, . . . , and 300-Y are provided on the map. The visual elements indicate bottlenecks and/or other traffic on the main thoroughfares. Any suitable visual indication may be used to identify problems. For example, color, cross-hatching, shading, shapes, blinking and/or other techniques may be used to identify high traffic zones, low speed zones, construction zone, and/or accident zones. For example, visual element 300-3 may be rendered in red and flashing to signify an accident. Speeds on the thoroughfare also provide an indication of a problem (e.g. the speeds decrease as the distance to the accident 300-3 decreases).

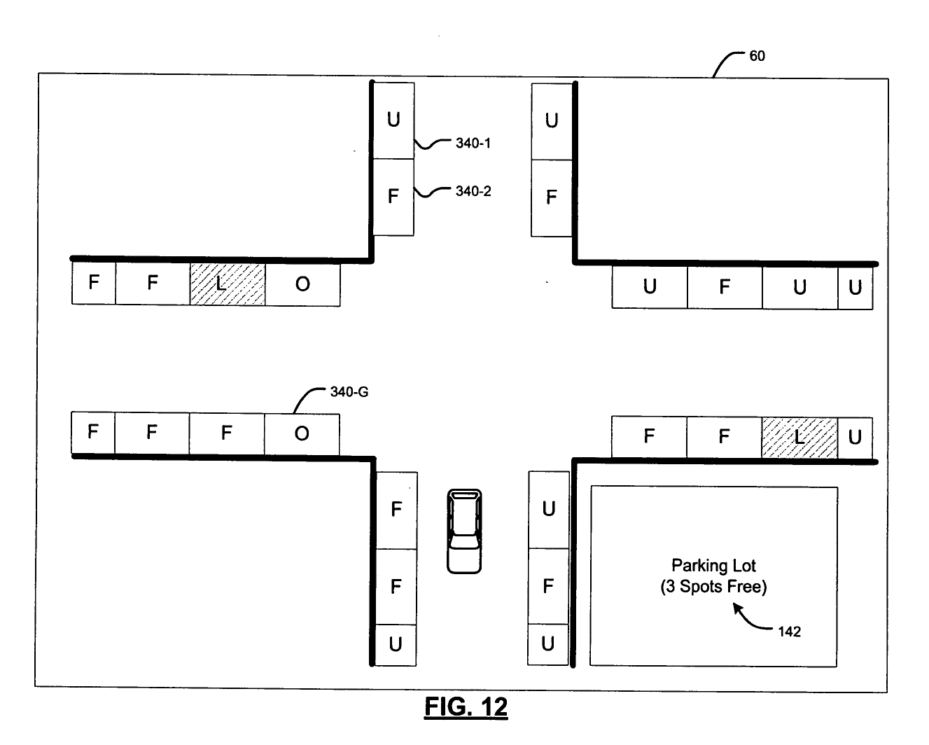

Referring now to FIG. 12, an exemplary display of available parking in the vicinity of the vehicle is shown. Based on information collected, the display 60 of the GPS 62 can be used to identify available parking spaces 340-1, 340-2, . . . , and 340-G in a selected area. The traffic monitoring system may provide filled (F), leaving (L), open (O) and/or unknown (U) status data for parking spaces in a selected area. These indicators may be designated using any suitable visual indication.

The filled indicator is used when a vehicle with the GPS system parks in the spot and the traffic monitoring system does not receive data indicating that the vehicle has moved. The unknown indicator is used when there is no information concerning the space and/or after a predetermined amount of time after a vehicle with a GPS system leaves a parking spot. A leaving indicator is used within a predetermined time after a vehicle with a GPS system leaves a parking spot. The leaving indicator may also be triggered when a vehicle with a GPS system starts its engine after a dwell period. The open status is used when the space is open. In some implementations, the status is provided by smart parking meters 138. Spaces in smart parking lots 142 may also be shown at 342.

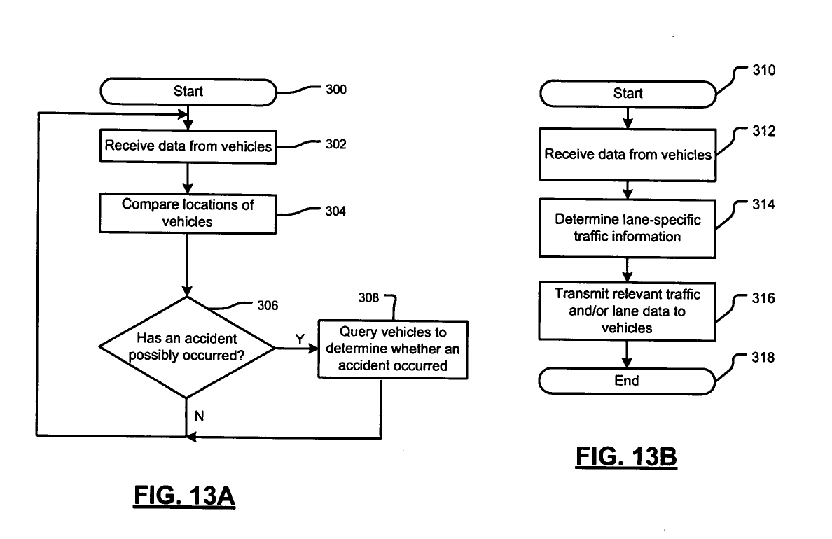

Referring now to FIG. 13A, steps for identifying accidents are shown. Control begins in step 300. In step 302, the traffic monitoring system receives data from vehicles. In step 304, the traffic monitoring system compares locations of the vehicles at the same time. Based on the location and time, the traffic monitoring system can determine whether an accident may have occurred. If the vehicles have substantially the same location at the same time, the traffic monitoring system may query the users to determine whether an accident has occurred in step 308. In other words, if two vehicles provide their location at a particular time and the locations conflict, the traffic monitoring system may assume that there is a possibility that an accident occurred and take action via the remote service assistance system. The traffic monitoring system can also determine which lane the accident occurred in and which lanes the accident is blocking.

Referring now to FIG. 13B, steps for updating traffic information based on lanes that vehicles are traveling in are shown. Control begins in step 310. In step 312, the traffic monitoring system receives data from vehicles. In step 314, the traffic monitoring system determines lane-specific traffic information based on the data. For example, the traffic monitoring system determines which lanes of a particular thoroughfare that vehicles are traveling in based on the data. The traffic monitoring system can determine average speeds of vehicles and accident locations in specific lanes. The traffic monitoring system can further determine lane changes and lane change frequency based on the data. For example, when an accident is located in a first lane, the data may indicate that a plurality of vehicles are changing from the first lane to a second or third lane. The data may also indicate that vehicles are changing lanes to avoid a non-vehicle obstruction in a lane, such as a pothole or vehicle debris.

In step 316, the traffic monitoring system notifies vehicles of the traffic information and/or the vehicle requests the traffic information using an inquiry/response technique. In addition to the traffic information, the traffic monitoring system may transmit suggested lane changes to the vehicle to avoid accidents and/or lane obstructions. Control ends in step 318.

Referring now to FIG. 14, a subscriber service according to the present invention is shown. Control begins in step 320. In step 324, fees are charged for subscription services. The fees can be based on the level of service that is requested. In step 328, data is collected from at least one of subscribing and non-subscribing vehicles and/or from smart parking meters and/or lots. In some implementations, data from other subscriber systems may be used. In step 332, data is analyzed and traffic, parking and other information is generated. In step 334, selected traffic, parking and/or other information is sent to subscribers based on subscribed services of the user. For example, some users may pay a subscription fee to receive traffic information but not parking information. Other subscribers may receive either parking information only or traffic and parking information. The subscriber levels may also be differentiated based on geography, time of day and/or using other criteria. Control ends in step 338.

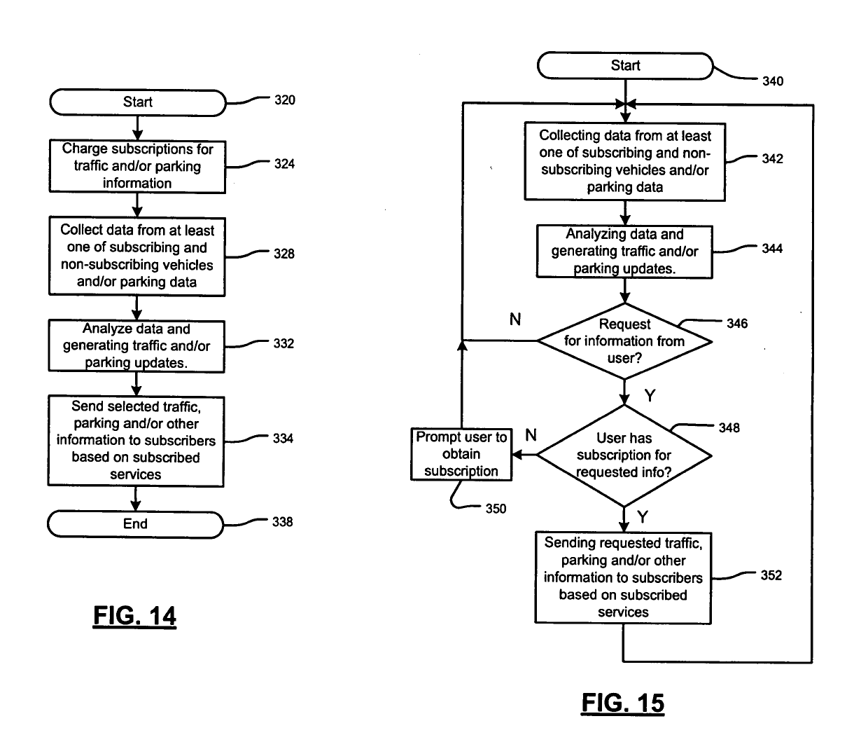

Referring now to FIG. 15, another exemplary subscriber service according to the present invention is shown. Control begins in step 340. In step 342, data is collected from at least one of subscribing and non-subscribing vehicles and/or from smart parking meters and/or lots. In step 344, data that is collected is analyzed and traffic, parking and other information is updated. In step 346, control determines whether a request for information is received. Alternately, the information can be pushed to the user based on the subscription of the user. If step 346 is false, control returns to step 342. If step 346 is true, control determines whether the user has a subscription for the requested information. If false, control prompts the user to obtain a subscription. The subscriptions can be on a periodic basis, a pay-per-use basis or on any other basis. If step 348 is true, the requested information is sent to the subscriber. As can be appreciated, encryption and/or other techniques may be used to prevent fraudulent access to the traffic and/or parking information.

Those skilled in the art can now appreciate from the foregoing description that the broad teachings of the present invention can be implemented in a variety of forms. As can be appreciated, steps of methods disclosed and claimed can be performed in an order that is different than that described and claimed herein without departing from the spirit of the present invention. Therefore, while this invention has been described in connection with particular examples thereof, the true scope of the invention should not be so limited since other modifications will become apparent to the skilled practitioner upon a study of the drawings, the specification and the following claims.

What is claimed is:

1. A traffic information system for a vehicle, comprising:
a global positioning system (GPS) associated with said vehicle that selectively generates location and vector data;
a transmitter; and
a control module that receives said location and vector data and that wirelessly transmits said location and vector data using said transmitter, wherein a remote traffic monitoring system that receives the location and vector data determines a first lane that the vehicle is located in based on at least the location and vector data.

2. The traffic information system of claim 1 further comprising a receiver that communicates with said control module and that wirelessly receives traffic reports from the remote traffic monitoring system.

3. The traffic information system of claim 2 wherein said traffic reports include traffic speed information for traffic traveling on at least the first lane.

4. A system comprising the traffic information system of claim 2 and further comprising a service assistance system that communicates with said control module and that wirelessly communicates with a remote service assistance system.

5. The system of claim 4 further comprising said remote traffic monitoring system that receives said vector and location data, that compares a speed of said vehicle in the first lane to a first threshold and to at least one of an average traffic speed on a road including the first lane and an average traffic speed of a second lane, and that selectively triggers contact with said vehicle using said service assistance system and said remote service assistance system.

6. The system of claim 5 wherein the road includes the second lane.

7. The traffic information system of claim 1 wherein said control module transmits said vector and location data on a periodic basis.

8. The traffic information system of claim 1 wherein said control module monitors lane changes of said vehicle and transmits said vector and location data when said vehicle changes lanes greater than a lane change frequency threshold.

9. The traffic information system of claim 1 wherein said control module monitors changes in speed of said vehicle and transmits said vector and location data when said vehicle speed change is greater than a speed change threshold.

10. The traffic information system of claim 1 wherein said control module is integrated with said GPS.

11. The traffic information system of claim 1 further comprising the remote traffic monitoring system that determines a lane of an accident based on at least the location and vector data.

12. The traffic information system of claim 1 wherein the remote traffic monitoring system generates a lane change suggestion according to the location and vector data.

13. The traffic information system of claim 1 wherein the remote traffic monitoring system determines a direction of travel of the vehicle based on the location and vector data.

14. The traffic information system of claim 2 wherein the traffic reports include a confidence level associated with the location and vector data.

15. The traffic information system of claim 14 wherein the confidence level is high when the location and vector data indicates that the vehicle is traveling at a first speed and the confidence level is low when the location and vector data indicates that the vehicle is traveling at a second speed.

16. A traffic information system for a vehicle, comprising:
global positioning means associated with said vehicle for selectively generating location and vector data;
transmitting means for transmitting data; and
control means for receiving said location and vector data and for wirelessly transmitting said location and vector data using said transmitting means, wherein said control means communicates with remote traffic monitoring means for receiving the location and vector data and for determining a first lane that the vehicle is located in based on at least the location and vector data.

17. The traffic information system of claim 16 further comprising receiving means for communicating with said control means and for wirelessly receiving traffic reports from the remote traffic monitoring means.

18. The traffic information system of claim 17 wherein said traffic reports include traffic speed information for traffic traveling on at least the first lane.

19. A system comprising the traffic information system of claim 17 and further comprising service assistance means for communicating with said control means and for wirelessly communicating with remote service assistance means for receiving said vector and location data.

20. The system of claim 19 further comprising said remote traffic monitoring means for comparing a speed of said vehicle in the first lane to a first threshold and to at least one of an average traffic speed on a road including the first lane and an average traffic speed of a second lane, and for selectively triggering contact with said vehicle using said service assistance means and said remote service assistance means.

21. The system of claim 20 wherein the road includes the second lane.

22. The traffic information system of claim 16 wherein said control means transmits said vector and location data on a periodic basis.

23. The traffic information system of claim 16 wherein said control means monitors lane changes of said vehicle and transmits said vector and location data when said vehicle changes lanes greater than a lane change frequency threshold.

24. The traffic information system of claim 16 wherein said control means monitors changes in speed of said vehicle and transmits said vector and location data when said vehicle speed change is greater than a speed change threshold.

25. The traffic information system of claim 16 wherein said control means is integrated with said GPS.

26. The traffic information system of claim 16 further comprising said remote traffic monitoring means for determining a lane of an accident based on at least the location and vector data.

27. The traffic information system of claim 16 wherein said remote traffic monitoring means generates a lane change suggestion according to the location and vector data.

28. The traffic information system of claim 16 wherein the remote traffic monitoring means determines a direction of travel of the vehicle based on the location and vector data.

29. The traffic information system of claim 17 wherein the traffic reports include a confidence level associated with the location and vector data.

30. The traffic information system of claim 29 wherein the confidence level is high when the location and vector data indicates that the vehicle is traveling at a first speed and the confidence level is low when the location and vector data indicates that the vehicle is traveling at a second speed.

31. A method of monitoring traffic information for a vehicle, comprising:
selectively generating location and vector data of said vehicle;
receiving said location and vector data at a control module;
wirelessly transmitting said location and vector data;
receiving said location and vector data at a remote traffic monitoring system; and
determining a first lane that the vehicle is located in based on at least the location and vector data at said remote traffic monitoring system.

32. The method of claim 31 further comprising wirelessly receiving traffic reports from the remote traffic monitoring system.

33. The method of claim 32 wherein said traffic reports include traffic speed information for traffic traveling on at least the first lane.

34. The method of claim 32 further comprising:
communicating with a service assistance system; and
wirelessly communicating with a remote service assistance system.

35. The method of claim 34 further comprising:
comparing a speed of said vehicle in the first lane to a first threshold and to at least one of an average traffic speed on a road including the first lane and an average traffic speed of a second lane; and
selectively triggering contact with said vehicle using said service assistance system and said remote service assistance system.

36. The method of claim 35 wherein the road includes the second lane.

37. The method of claim 31 further comprising wirelessly transmitting said location and vector data on a periodic basis.

38. The method of claim 31 further comprising:
monitoring lane changes of said vehicle; and
transmitting said vector and location data when said vehicle changes lanes greater than a lane change frequency threshold.

39. The method of claim 31 further comprising;
monitoring changes in speed of said vehicle; and
transmitting said vector and location data when said vehicle speed change is greater than a speed change threshold.

40. The method of claim 31 further comprising integrating said control module with a global positioning system (GPS).

41. The method of claim 31 further comprising determining a lane of an accident based on at least the location and vector data.

42. The method of claim 31 further comprising generating a lane change suggestion according to the location and vector data.

43. The method of claim 31 further comprising determining a direction of travel of the vehicle based on the location and vector data.

44. The method of claim 31 further comprising generating a confidence level associated with the location and vector data.

45. The method of claim 44 wherein the confidence level is high when the location and vector data indicates that the vehicle is traveling at a first speed and the confidence level is low when the location and vector data indicates that the vehicle is traveling at a second speed.
